(19) United States
(12) Patent Application Publication
(10) Pub. No.: US 2011/0272923 A1
(43) Pub. Date: Nov. 10, 2011

(54) FOLDING MECHANISM AND FOLDABLE STROLLER

(76) Inventor: Shun-Min Chen, Central (HK)

(21) Appl. No.: 12/965,912

(22) Filed: Dec. 12, 2010

(30) Foreign Application Priority Data
May 7, 2010 (CN) 201010178061.9

(51) Int. Cl. B62B 7/06; E05D 5/00

(52) U.S. Cl. 280/649; 280/650; 16/382

(57) ABSTRACT

The invention relates to a stroller. A folding mechanism and a foldable stroller with the folding mechanism are disclosed. The folding mechanism includes a pivot device, a first support member, and a second support member. The first support member is pivotally connected to the second support member by the pivot device. The second support member includes a curve portion. There is a gap formed between the first support member and the second support member by the curve portion for preventing fingers from being trapped when the first support member and the second support member pivot close to each other. Thereby, it can prevent fingers from being trapped during folding the foldable stroller, even close to the pivot device.

### BACKGROUND OF THE INVENTION

1. Field of the Invention

The invention relates to a folding mechanism for a stroller and a foldable stroller, and especially relates to a folding mechanism for a stroller and a foldable stroller capable of preventing fingers from being trapping during folding the foldable stroller.

2. Description of the Prior Art

Based on the requirement for small package volume and convenience of carry, there exists a foldable stroller. The manner usually is to design a foldable frame of a stroller by utilizing a pivot device for reducing the volume.

Please refer to FIG. 1, which is a schematic diagram of a stroller 1 in the prior art. A frame of the stroller 1 is formed by a plurality of pivotally connected bars. The frame includes a pivot device 12 which includes a first pivotal part 122 and a second pivotal part 124 pivotally connected to each other. The first pivotal part 122 and the second pivotal part 124 are connected to a first support member 14 and a second support member 16 respectively. Please also refer to FIG. 2, which is a schematic diagram of the pivot device 12, the first pivotal part 122, and the second pivotal part 124 when the frame is folded in the prior art. When the stroller 1 is being folded, the first pivotal part 122 and the second pivotal part 124 pivot close to each other, and the first support member 14 and the second support member 16 are close to each other accordingly.

Obviously, there is no much space in the dashed-line ellipse region in FIG. 2. In a practical design, the shorter distance between the first pivotal part 122 and the second pivotal part 124 or between the first support member 14 and the second support member 16 is desired, for obtaining the volume reduction for the folded frame as maximum as possible. However, it is quite possible that during the folding process of the stroller 1, a finger carelessly disposed between the first pivotal part 122 and the second pivotal part 124 (or the first support member 14 and the second support member 16) or a hand of a child extending into the frame is hurt by being trapped by the frame, even to be broken if serious. It may lead to an irreparable regret.

Please refer to FIG. 3, which is a schematic diagram of the pivot device 12 with a larger volume in the prior art. As shown in FIG. 3, because the pivot device 12 has a larger volume, a stop part 126 can be designed within the pivot device 12 for preventing the first pivotal part 122 and the second pivotal part 124 from being excessively close. Therefore, there is quite large space reserved in the dashed-line ellipse region in FIG. 3 for avoiding hurting a finger of a user carelessly disposed therein during the folding process. However, the large pivot device 12 does not make the volume of the folded stroller 1 reduced effectively. In addition, as shown in FIG. 2, in order to reserve enough space between the first pivotal part 122 and the second pivotal part 124 (or the first support member 14 and the second support member 16) for avoiding the problem of trapping fingers, the first support member 14 and the second support member 16 are closed to each other with a bigger open angle, which makes the folded volume of the stroller 1 increase. It is contrary to the purpose of reducing the volume of the stroller 1 for package or carry.

### SUMMARY OF THE INVENTION

An objective of the invention is to provide a folding mechanism. When two support members of the folding mechanism are folded, there is a space formed at the pivotal connection of the two support members for avoiding trapping an object such as a finger carelessly disposed therein.

The folding mechanism of the invention is applied to a frame. The folding mechanism includes a pivot device which includes a first pivotal part and a second pivotal part pivotally connected to the first pivotal part, a first support member where the first pivotal part is mounted thereon, and a second support member where the second pivotal part is mounted thereon. The second support member includes a curve portion. There is a gap formed between the first support member and the second support member by the curve portion for preventing fingers from being trapped when the first support member and the second support member pivot close to each other. The existence of the gap makes it possible that an object such as a finger carelessly disposed between the first support member and the second support member can evade in the gap for avoiding being seriously trapped during the process of folding the frame.

Another objective of the invention is to provide a foldable stroller with the folding mechanism. The foldable stroller can prevent a finger from being trapped and maintain a smaller volume of the foldable stroller after folded.

The foldable stroller of the invention includes the folding mechanism of the invention. The foldable stroller includes a frame which includes the folding mechanism. The folding mechanism is described above and no longer described in the following description. Therefore, the gap is formed between the first support member and the curve portion. The existence of the gap makes it possible that an object such as a finger carelessly disposed between the first support member and the second support member of the frame can evade in the gap for avoiding being seriously trapped during the process of folding the foldable stroller.

Compared with the prior art, the invention designs the geometric shape of the structure of the frame to make the gap formed when the frame is in a folded state. The gap allows an object to evade therein for avoiding trapping the object carelessly disposed between the first support member and the second support member. In addition, compared with the pivot device designed with the stop structure in the prior art, the invention designs the geometric shape of the structure of the frame to reduce the design complexity for keeping the advantage of the pivot device with a small volume and the stability in operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a stroller in the prior art.

FIG. 2 is a schematic diagram of a pivot device, a first pivotal part, and a second pivotal part when a frame is folded in the prior art.

FIG. 3 is a schematic diagram of the pivot device with a larger volume in the prior art.

FIG. 4 is a perspective schematic diagram of a foldable stroller according to a preferred embodiment of the present invention.

FIG. 5 is a schematic diagram of partially enlarged portions of a pivot device, a first support member, and a second support member according to the preferred embodiment of the present invention.

FIGS. 6 through 8 are side views of the foldable stroller for showing the folding operation of the foldable stroller in serial diagrams according to the preferred embodiment of the present invention.

FIG. 9 is a schematic diagram of partially enlarged portions of the pivot device, the first support member, and the second support member when the foldable stroller is folded according to the preferred embodiment of the present invention.

FIG. 10 is a schematic diagram of partially enlarged portions of the pivot device, the first support member, and the second support member when the foldable stroller is folded according to another embodiment of the present invention.

FIG. 11 is a schematic diagram of partially enlarged portions of the pivot device, the first support member, and the second support member when the foldable stroller is folded according to another embodiment of the present invention.

FIG. 12 is a schematic diagram of partially enlarged portions of the folding mechanism according to another embodiment of the present invention.

FIG. 13 is a schematic diagram of a folding mechanism according to another embodiment of the present invention.

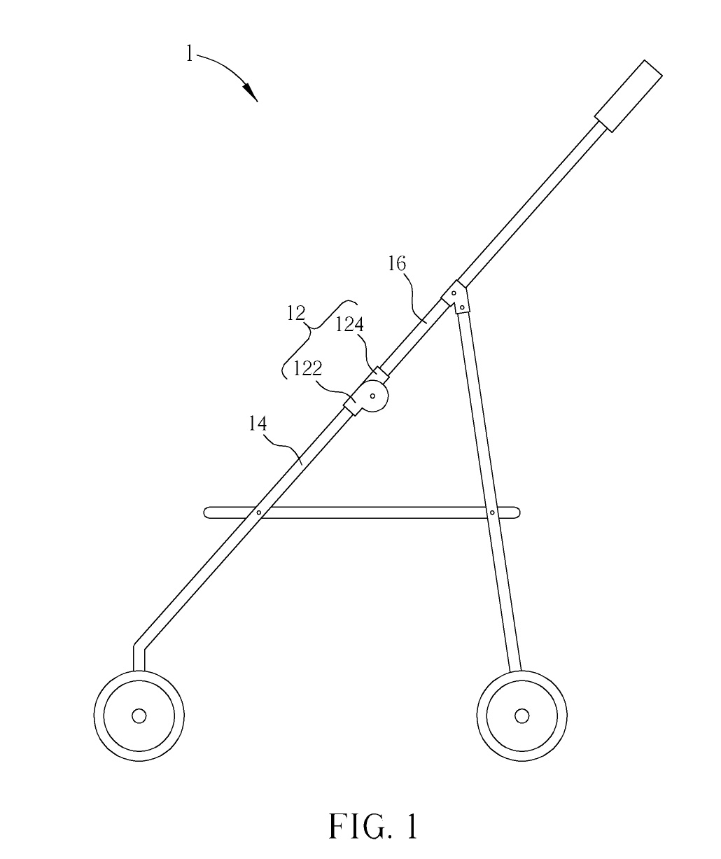

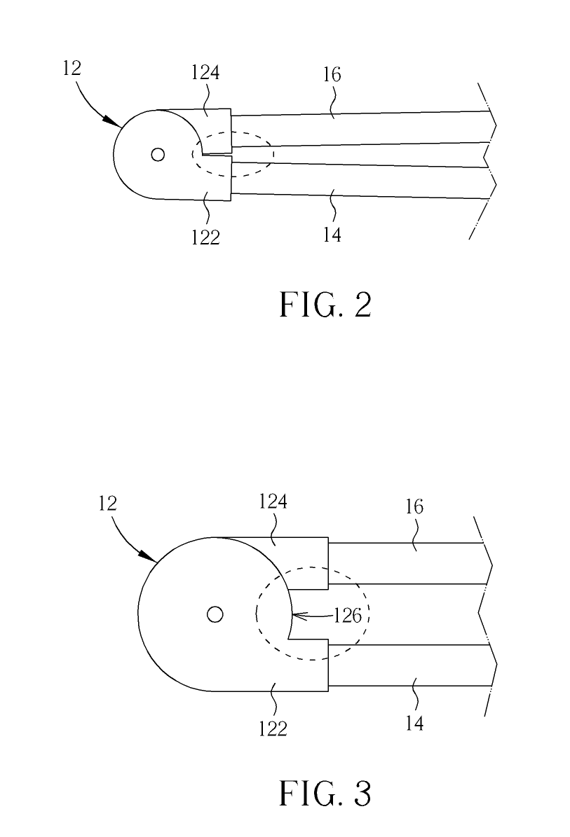

### DETAILED DESCRIPTION

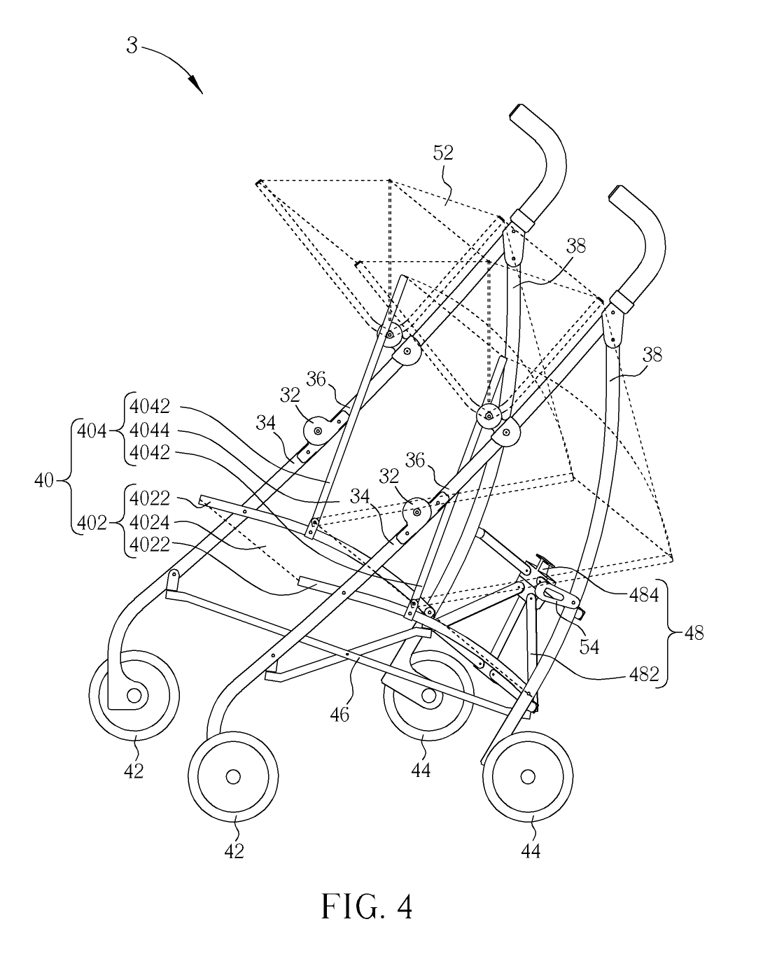

Please refer to FIG. 4, which is a perspective schematic diagram of a foldable stroller 3 according to a preferred embodiment of the present invention. The frame of the foldable stroller 3 is shown in solid lines; the canopy and the seat fabric are shown in dashed lines. The frame includes two side frames disposed symmetrically. Each side frame includes a pivot device 32, a first support member 34, a second support member 36, and a rear-leg support member 38. An upper end of first support member 34 is pivotally connected to a lower end of the second support member 36 by the pivot device 32. An upper end of the rear-leg support member 38 is pivotally connected to an upper end of the second support member 36. In this embodiment, the first support member 34 is a front-leg support member. A lower end of the first support member 34 is pivotally connected to a front wheel 42. A lower end of the rear-leg support member 38 is pivotally connected to a rear wheel 44. A handle is formed on the upper end of the second support member 36 for holding.

The frame further includes a seat 40, an X-shaped support member 46, and a folding-actuation mechanism 48 between the side frames. In this embodiment, the seat 40 includes a seat part 402 and a backrest part 404 pivotally connected to the seat part 402. The seat part 402 includes two seat tubes 4022 and a seat fabric 4024 disposed on the two seat tubes 4022 for a baby to seat. A front end of each seat tube 4022 is pivotally connected to the first support member 34 of the corresponding side frame. A rear end of each seat tube 4022 is pivotally connected to a lower portion of the rear-leg support member 38 of the corresponding side frame. The backrest part 404 includes two backrest tubes 4042 and a seat fabric 4044 disposed on the two backrest tubes 4042. Each backrest tube 4042 is pivotally connected to the corresponding seat tube 4022 for supporting the back of the baby. The backrest part 404 is adjustable in angle relative to the seat part 402. In FIG. 4, the lying position of the backrest tubes 4042 is shown in dashed lines.

The X-shaped support member 46 includes two cross-connected tubes which have four ends pivotally connected to the first support members 34 and the rear-leg support members 38 respectively. The folding-actuation mechanism 48 connects the rear-leg support member 38 of each side frame for locking the foldable stroller 3 at an opened state and for folding the frame after released it to make the side frames to close to each other so that the first support members 34, the second support members 36, the rear-leg support members 38, and the seat tubes 4022 are folded close to one another. Based on different designs to the folding-actuation mechanism 48, the connection between the folding-actuation mechanism 48 and the rear-leg support members 38 is not limited to figure as shown in FIG. 4.

It is added that, in FIG. 4, the frame of the foldable stroller 3 further includes a canopy 52 disposed between the second support members 36 of the two side frames for providing the shielding.

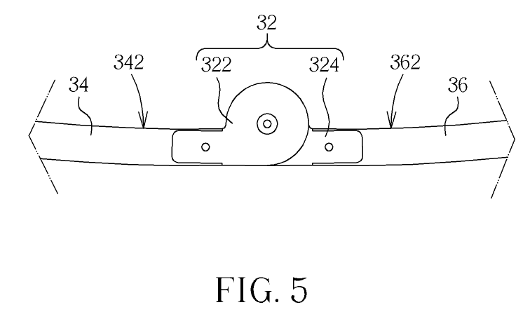

Please refer to FIG. 5, which is a schematic diagram of partially enlarged portions of the pivot device 32, the first support member 34, and the second support member 36 according to the preferred embodiment of the present invention. The pivot device 32 includes a first pivotal part 322 and a second pivotal part 324 pivotally connected to the first pivotal part 322. The first pivotal part 322 is mounted on the upper end of the first support member 34. The second pivotal part 324 is mounted on the lower end of the second support member 36. The second support member 36 includes a curve portion 362. In this embodiment, the curve profile of the curve portion 362 is formed in whole from the upper end to the lower end of the second support member 36; the first support member 34 also includes a curve portion 342, of which the curve profile is formed in whole from the upper end to the lower end of the first support member 34 and opposite to the curve profile of the curve portion 362 of the second support member 36. Furthermore, the first support member 34 and the second support member 36 form an entire continuous bent structure.

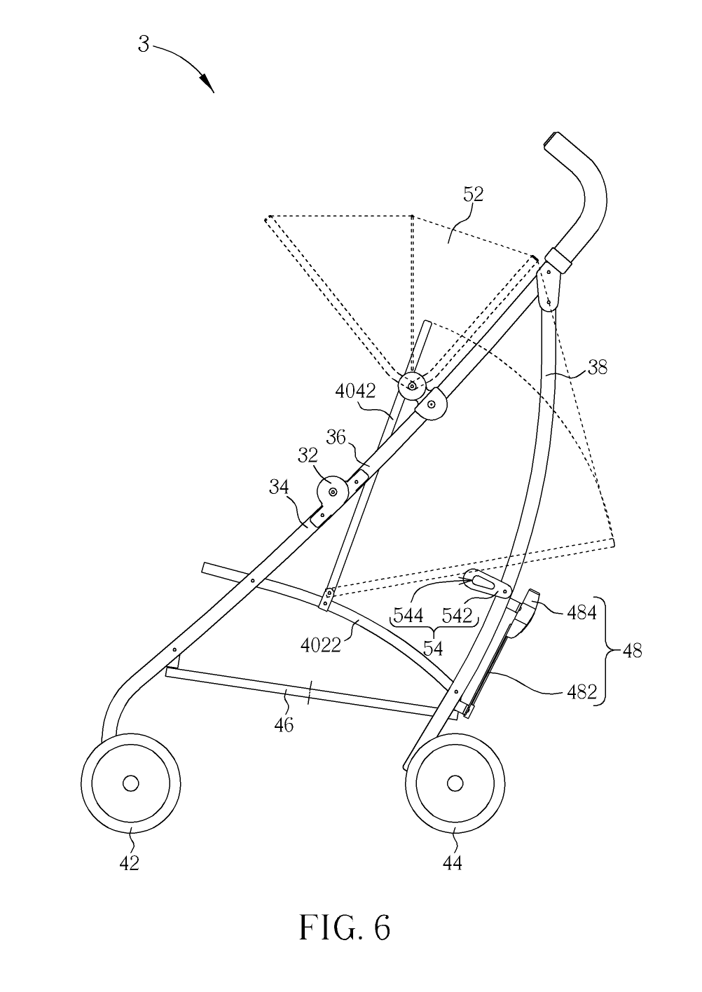

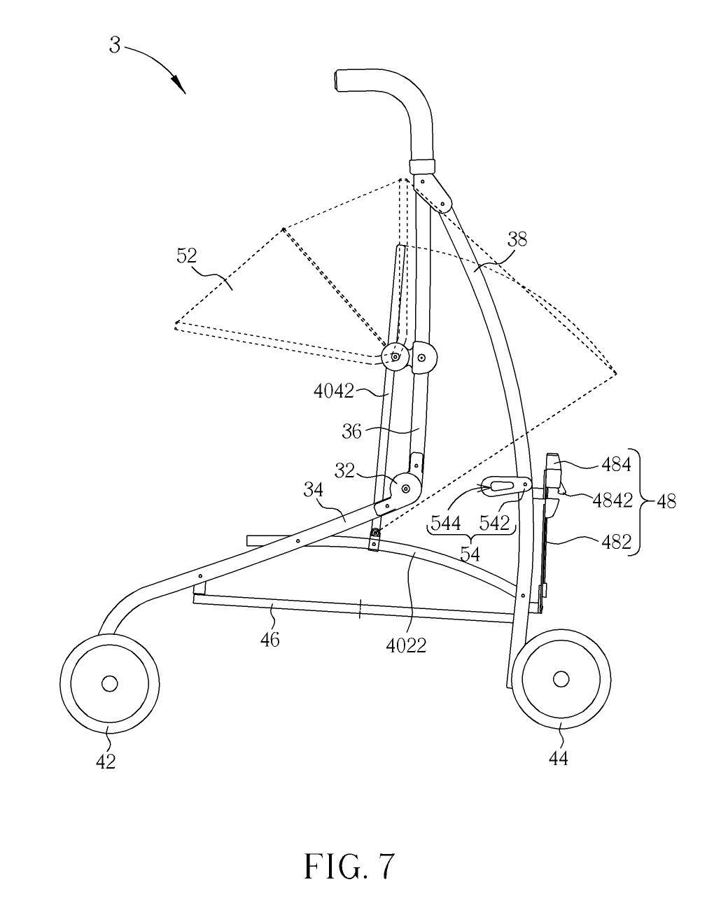

Please refer to FIGS. 6 through 8, which are side views of the foldable stroller 3 for showing the folding operation of the foldable stroller 3 in serial diagrams according to the preferred embodiment of the present invention. The description of the folding mechanism by operating the folding-actuation mechanism 48 is introduced later. Please also refer to FIG. 4. In this embodiment, the folding-actuation mechanism 48 includes a foldable support member 482 and a driving part 484 connected to the foldable support member 482. The foldable support member 482 mainly includes a plurality of bars pivotally connected to the rear-leg support members 38 in oblique and transversal directions and a longitudinal connection member connecting the bars. The driving part 484 is used for driving the connection member to fold the bars of the foldable support member 482. Therefore, the driving part 484 can be driven, the foldable support member 482 to be folded so as to bring the frame to collapse. Therein, when the driving part 484 is locked, the transversal bars, the oblique bars, and the connection member form a statically determinate truss structure, which increases the stability of the frame and retain the foldable stroller 3 at the opened state.

If a user wants to fold the foldable stroller 3, a latch 4842 locking the driving part 484 needs to be unlocked first. The driving part 484 is then pulled upward to make the foldable support member 482 be folded so as to close the side frames to each other for folding the frame. Because the two rear-leg support members 38 close to each other, the X-shaped support member 46 is driven to extend along front-to-back direction of the foldable stroller 3 so that the distance between the front wheel 42 and the rear wheel 44 increases; therein, the position of the cross center of the X-shaped support member 46 is shown in center line in FIG. 6 to FIG. 8. The linkage mechanism formed by the pivot device 32, the first support member 34, a second support member 36, the rear-leg support member 38, and the seat tube 4022 is driven due to the increment of the distance between the front wheel 42 and the rear wheel 44, so that the upper end of the first support member 34 rotates clockwise toward the seat tube 4022, the second support member 36 rotates counterclockwise toward the first support member 34, and the rear-leg support member 38 also rotates counterclockwise toward the first support member 34, the second support member 36, and the seat tube 4022 for collapsing.

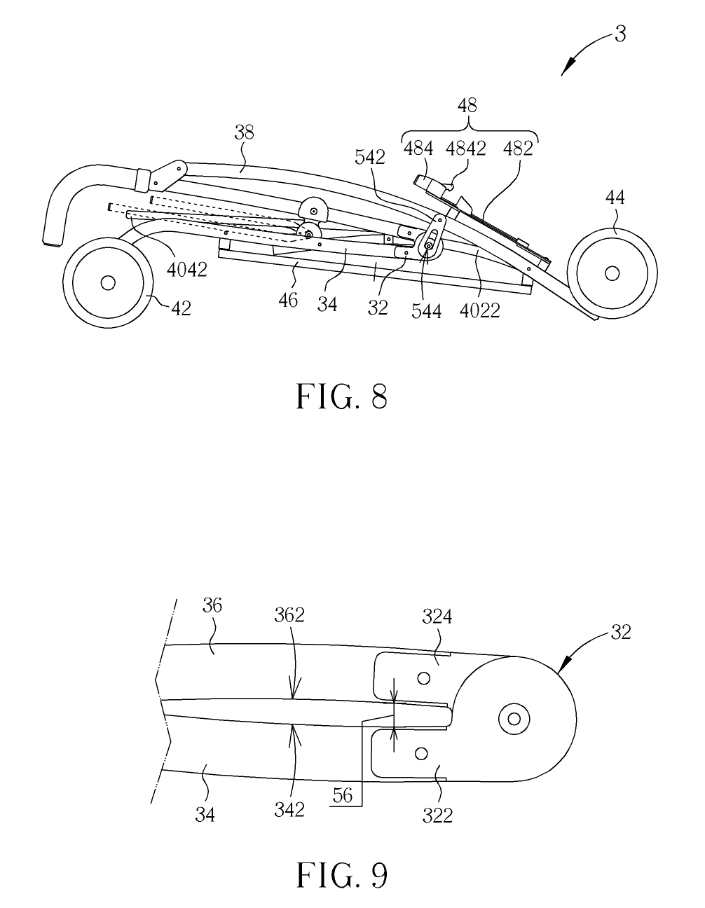

The canopy 52 is then accommodated therein. For clear illustration, the canopy 52 is presented only by its support frames shown in dashed lines in FIG. 8. It is added that the foldable stroller 3 includes a retaining member 54 which includes a mounting portion 542 and a holding portion 544. The mounting portion 542 is mounted on the rear-leg support member 38. The holding portion 544 hooks the pivot device 32, such as a protruding axle thereof or another protrusion specially disposed thereon, when the foldable stroller 3 is folded. The retaining member 54 may have an inclined surface on the front edge thereof so that the holding portion 544 can be guided to be coupled with the pivot device 32 automatically for holding the foldable stroller 3 when folded. It is noticed additionally that the retaining member 54 is mounted on the rear-leg support member 38 of only one of the side frames in this embodiment, but the invention is not limited to this. The retaining member 54 also can be used on the other rear-leg support member 38. The place of the frame for the hooking by the retaining member 54 is not limited to the pivot device 32. The place may be another portion of the frame, which is also capable of keeping the folded foldable stroller 3 in a folded state.

Please refer to FIG. 9, which is a schematic diagram of partially enlarged portions of the pivot device 32, the first support member 34, and the second support member 36 when the foldable stroller 3 is folded according to the preferred embodiment of the present invention. Obviously, because the curve portion 342 of the first support member 34 and the curve portion 362 of the second support member 36 are opposite to each other and formed by bending in whole, an approximate V-shaped structure is formed by the first support member 34 and the second support member 36 near the pivot device 32 when the first support member 34 and the second support member 36 are folded, and a gap 56 is therefore formed. The existence of the gap 56 is prevented fingers trapping of the user or another person carelessly disposed between the first support member 34 and the second support member 36. The size of the gap 56 can be designed according to the specification of a practical product. The gap 56 can be at least 12 mm for allowing the finger to pass through free. For this value, even a finger of an adult disposed between the first support member 34 and the second support member 36 is subjected to being compressed at most. It seems unlikely to produce destructive damage or injury. In addition, in this embodiment, the first support member 34 and the second support member 36 are curved, so the ends of the first support member 34 and the second support member 36 still approach to each other. The structure with a V-shaped open will not appear on the ends of the first support member 34 and the second support member 36. Therefore, the volume of the folded foldable stroller 3 is still smaller than the volume of the folded stroller with the larger pivot device in the prior art.

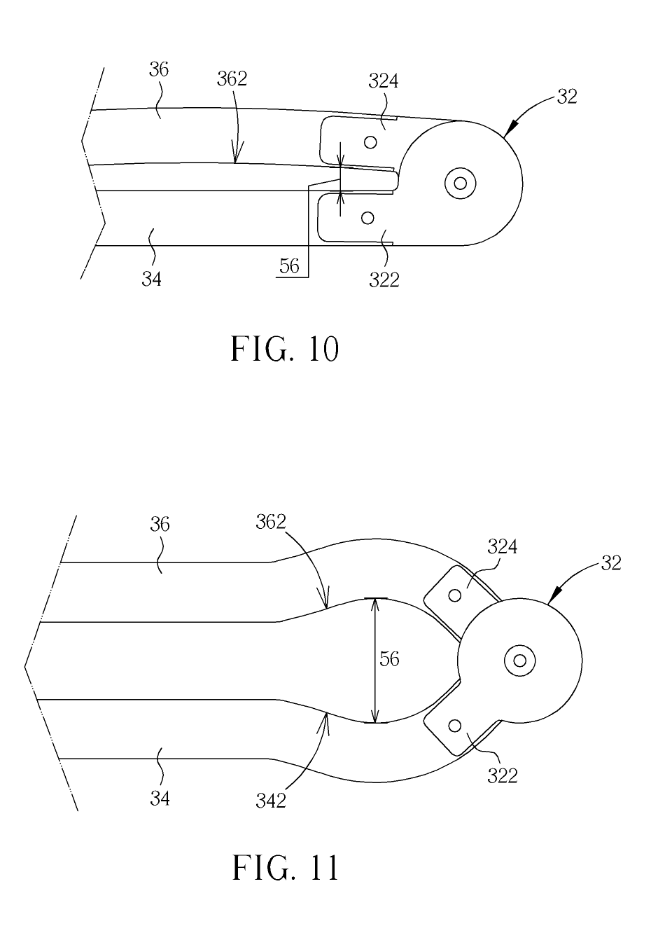

Although the embodiment in FIG. 4 takes the example of the first support member 34 and the second support member 36 being bent in whole to form the curve portions 342 and 362, the invention is not limited to this. Please refer to FIG. 10, which is a schematic diagram of partially enlarged portions of the pivot device 32, the first support member 34, and the second support member 36 when the foldable stroller 3 is folded according to another embodiment. In FIG. 10, the folding mechanism formed by the pivot device 32, the first support member 34, and the second support member 36 is similar to the folding mechanism in FIG. 4. The difference lies only in that the first support member 34 does not have the curve portion 342 and the second support member 36 has the curve portion 362. The curve of the curve portion 362 can be a little larger than that in the first embodiment, so that a gap 56 still exists at the pivot device 32 when the foldable stroller 3 is folded. The size of this gap 56 is required to allow a finger to pass through free. As described above, the gap 56 is preferred to be at least 12 mm. The gap 56 can be formed in a required size by changing the bending curvature of the curve portion 362 of the second support member 36.

It is added that although the support members of the foldable stroller 3 in FIG. 4 can be made of tubes, and the curve portions 342 and 362 can be achieved by bending the tubes to reduce the production cost and the design complexity of product structure, the invention is not limited to this. For example, the support members can be made of plates. In addition, in the above embodiments, the curve portions are formed by bending the support members in whole, but the invention is not limited to this. Please refer to FIG. 11, which is a schematic diagram of partially enlarged portions of the pivot device 32, the first support member 34, and the second support member 36 when the foldable stroller 3 is folded according to another embodiment. In FIG. 11, the first support member 34 and the second support member 36 can be formed with a portion in straight tube structure and a portion near the pivot device 32 to be formed as bent structure, which can form the gap 56 for preventing fingers from being trapped equally. Furthermore, in this embodiment, the distance between the portions of the first support member 34 and the second support member 36 away from the pivot device 32 is smaller. According to the principle of lever, the trapping force at the portions of the first support member 34 and the second support member 36 is smaller than that near the pivot device 32. Further, because of other components of the frame (such as the canopy 52), the trapping force on fingers by the portions of the first support member 34 and the second support member 36 away from pivot device 32 is reduced more when the foldable stroller 3 is folded.

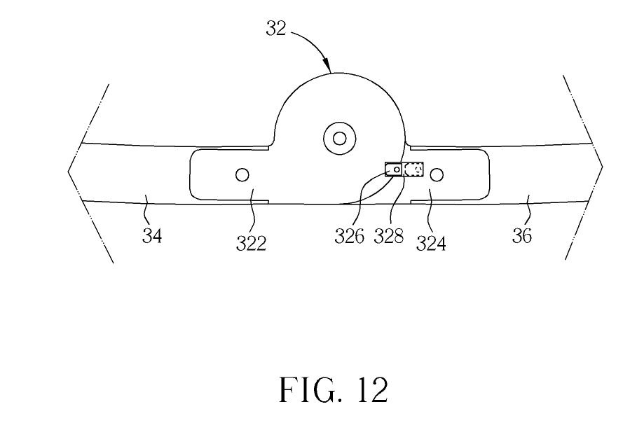

The embodiment in FIG. 4 shows that the foldable stroller 3 is folded completely at same time of driving linkage by the linkage mechanism after the latch 4842 is unlocked, but the invention is not limited to this. In other words, the rotation and folding of the side frames and the approaching of side frames to each other can be operated separately. Please refer to FIG. 12, which is a schematic diagram of partially enlarged portions of the folding mechanism according to another embodiment. In this case, the pivot device 32 includes a latch 326 for locking the first pivotal part 322 with the second pivotal part 324 for avoiding the occurrence of an unexpected folding operation. The pivot device 32 includes a slide slot 328 on the first pivotal part 322 and the second pivotal part 324 for the latch 326 to slide within the slide slot 328 to releasable lock the first pivotal part 322 with the second pivotal part 324. In another embodiment, a through hole can be formed on the pivot device 32 that is passed through the first pivotal part 322 and the second pivotal part 324. A pin is worked as a latch for being inserted into the through hole so that the function of locking the first pivotal part 322 with the second pivotal part 324 can also be achieved. Therefore, unlocking of the first pivotal part 322 with the second pivotal part 324 is performed by extracting the pin.

It is further added that, the embodiment in FIG. 4 shows that the foldable stroller 3 is folded completely at same time by driving of the folding-actuation mechanism 48 due to the linkage mechanism formed by the side frames. Therefore, the latch 4842 for locking the driving part 484 is disposed on the folding-actuation mechanism 48 so as to avoid an unexpected folding operation. In order to avoid mistaken-operating the driving part 484 to fold the foldable stroller 3, the locking mechanisms shown in FIG. 4 and FIG. 12 can be used simultaneously, or the folding-actuation mechanism 48 can be equipped with another locking mechanism besides the latch 4842. In this case, to fold the foldable stroller 3 needs to release the two locking mechanisms.

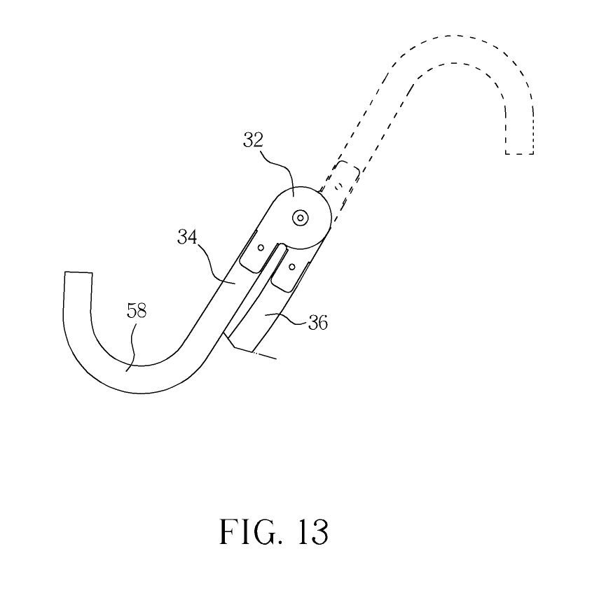

It is understood based on the above embodiments that the folding mechanism of the invention can prevent fingers from being trapped. In the above embodiments, each frame of the foldable stroller has only one pivot device on main support members thereof for preventing the fingers from being trapped during the folding process; however, the invention is not limited to this. Please refer to FIG. 13, which is a schematic diagram of a folding mechanism according to another embodiment. The folding mechanism is applied to a frame with a handle 58 for parents to hold. The handle 58 is capable of rotating relative to the frame of a stroller to reduce the volume of the folded frame or to adjust the height of the handle 58. In FIG. 13, the dashed lines present the position of the handle 58 prior to being folded. The folding mechanism, like the folding mechanism in the above embodiments, includes a pivot device 32, a first support member 34, and a second support member 36. The first support member 34 is pivotally connected to the second support member 36 by the pivot device 32. The folding mechanism in FIG. 13 is applied to the portion of the frame where the handle 58 is located, so an upper end of the first support member 34 of the folding mechanism extends upwards to form the handle 58, and the second support member 36 is connected to other portion of the frame. Similar to the above embodiments, the first support member 34 and the second support member 36 simultaneously have curve portions, or only one of the support members has the curve portion. There is a gap formed between the first support member 34 and the second support member 36 when the folding mechanism is folded. The gap also has the function of preventing fingers from being trapped.

Compared with the prior art, the invention designs the geometric shape of the structure of the frame near the pivot device to make the gap formed when the pivot device is in the folded state. The gap allow an object (such as a finger) to evade therein for avoiding being trapped. In addition, compared with the pivot device designed with the stop structure in the prior art, the design for the folding mechanism of the invention can reduce the design complexity for the pivot device to be with the advantage of small volume and the stability in operation.

Those skilled in the art will readily observe that numerous modifications and alterations of the device and method may be made while retaining the teachings of the invention.

What is claimed is:

1. A folding mechanism for a folding frame, the folding mechanism comprising:
a pivot device comprising a first pivotal part and a second pivotal part, the first pivotal part being pivotally connected to the second pivotal part;
a first support member where the first pivotal part is mounted thereon; and
a second support member where the second pivotal part is mounted thereon, the second support member comprising a curve portion, there being a gap formed between the first support member and the second support member by the curve portion for preventing fingers from being trapped when the first support member and the second support member pivot close to each other.

2. The folding mechanism of claim 1, wherein the first support member comprises a curve portion opposite to the curve portion of the second support member.

3. The folding mechanism of claim 2, wherein the first support member and the second support member are respectively a tube member bent in whole to form the curve portion.

4. The folding mechanism of claims 1, wherein the curve portion is adjacent to the pivot device.

5. The folding mechanism of claim 1, wherein the second support member is a tube member bent in whole to form the curve portion.

6. The folding mechanism of claim 1, wherein the pivot device comprises a latch for releasable locking the first pivotal part with the second pivotal part.

7. The folding mechanism of claim 1, wherein the gap is at least 12 mm.

8. A stroller comprising a frame, the frame comprising two side frames, each of the side frames comprising:
a first support member; and
a second support member pivotally connected to the first support member, at least one of the first support member and the second support member comprising a curve portion, there being a gap formed between the first support member and the second support member by the curve portion for preventing fingers from being trapped when the first support member and the second support member pivot close to each other and the stroller is in a folded state.

9. The stroller of claim 8, wherein each of the side frames further comprises a rear-leg support member, an upper end of the rear-leg support member is pivotally connected to an upper end of the corresponding second support member, and the rear-leg support member moves toward the first support member and the second support member when the second support member and the first support member pivot close to each other.

10. The stroller of claim 9, wherein the frame comprises an X-shaped support member and a folding-actuation mechanism the X-shaped support member is pivotally connected to the first support members and the rear-leg support members respectively of the corresponding side frames, the folding-actuation mechanism is connected to the rear-leg support member of each side frame, and the folding-actuation mechanism is for driving the X-shaped support member by linkage, so that the first support member and the second support member pivot close to each other.

11. The stroller of claim 9, wherein the frame comprises a pivot device, an upper end of the first support member is pivotally connected to a lower end of the second support member by the pivot device, a retaining member is disposed on one of the rear-leg support members, and the retaining member is coupled with the pivot device so as to keep the frame being in the folded state when the frame is in the folded state.

12. The stroller of claim 8, wherein each of the first support member and the second support member comprises the curve portion, and the curve portions are opposite to each other.

13. The stroller of claim 12, wherein the first support member and the second support member are respectively a tube member bent in whole to form the curve portion.

14. The stroller of claims 12, wherein the gap is at least 12 mm.

15. The stroller of claims 8, wherein the gap is at least 12 mm.

16. The stroller of claim 8, wherein one of the first support member and the second support member is a tube member bent in whole to form the curve portion.

17. The stroller of claim 8, wherein the frame comprises a pivot device, an upper end of the first support member is pivotally connected to a lower end of the second support member by the pivot device, and a handle is formed on an upper end of the second support member.
